(19) United States
(12) Patent Application Publication
(10) Pub. No.: US 2026/0177754 A1
(43) Pub. Date: Jun. 25, 2026

(54) REVERSIBLE POLARITY PUSH-PULL UNIT-BOOT CONNECTOR

(71) Applicant: Huizhou Fibercan Industrial Co.,Ltd, Huizhou (CN)

(72) Inventors: Songsheng LI, Huizhou (CN); Jianchao CHEN, Huizhou (CN)

(21) Appl. No.: 19/218,408

(22) Filed: May 26, 2025

(30) Foreign Application Priority Data
Dec. 24, 2024 (CN) 202411916985.2

(51) Int. Cl. G02B 6/38

(52) U.S. Cl. CPC G02B 6/3831; G02B 6/3893

(57) ABSTRACT

A reversible polarity push-pull unit-boot connector is provided, which includes an inner frame sleeve, an optical fiber cable, plugs, an outer frame sleeve, and an unlocking tail sleeve. The outer frame sleeve and the unlocking tail sleeve are unlocked, and then the outer frame sleeve and the inner frame sleeve are exited towards the fiber optic cable and are unlocked. When the entire unlocking tail sleeve is retracted to a position of the fiber optic cable, the outer frame sleeve is rotated 180 ° to exit towards an outside, then the outer frame sleeve is rotated 180 ° to exchange. Then the outer frame sleeve is pushed towards the inner frame sleeve until it buckles with the inner frame sleeve, the unlocking tail sleeve buckles with the inner frame sleeve and the unlocking tail sleeve buckles with the outer frame sleeve.

### CROSS-REFERENCE TO RELATED APPLICATIONS

This application claims priority to Chinese Patent Application No. 202411916985.2, filed on Dec. 24, 2024, which is hereby incorporated by reference in its entirety.

### TECHNICAL FIELD

The present disclosure relates to the field of signal transmission connector technologies, and in particular, to a reversible polarity push-pull unit-boot connector.

### BACKGROUND

Fiber optic connector is a device that can be disassembled and connected between optical fibers. It precisely connects two end faces of optical fibers to maximize the coupling of the optical energy output from the transmitting fiber to the receiving fiber. With the increasing demand for communication bandwidth, optical fibers have been widely used in wired communication networks. Most fiber optic systems today use a pair of fibers for transmission, one for forward signal transmission and the other for reverse transmission. When installing and maintaining such systems, special attention should be paid to whether the signal is transmitted on the corresponding optical fiber to ensure that the correct transmission and reception polarity is always maintained. The existing reversible polarity fiber optic connectors have overly complex structures and are inconvenient for polarity conversion. Besides that, many changeable polarity fiber optic connectors have unstable overall structures to perform polarity switching, which affects the overall signal transmission effect and service life. The present disclosure aims to solve the above problems.

### SUMMARY

In order to overcome shortcomings of existing technology, the present disclosure provides a reversible polarity push-pull unit-boot connector.

The technical solution adopted by the present disclosure to solve its technical problem is: a reversible polarity push-pull unit-boot connector, including an inner frame sleeve, a fiber optic cable fixedly connected to one end of the inner frame sleeve, a first pair of plugs and a second pair of plugs that are fixedly connected to the other end of the inner frame sleeve, an outer frame sleeve, and an unlocking tail sleeve; the outer frame sleeve is sleeved on the first pair of plugs and the second pair of plugs and is buckled with an outside of the inner frame sleeve; the fiber optic cable is connected to the first pair of plugs and the second pair of plugs, passes through the inner frame sleeve and is extended from inner frame sleeve; the unlocking tail sleeve is sleeved on an outside of the inner frame sleeve and is buckled with the outer frame sleeve; the outer frame sleeve is provided with a spring clip, and the unlocking tail sleeve is provided with a spring buckle, the spring buckle is buckled to the spring clip.

In some embodiments of the present disclosure, two sides of the inner frame sleeve are provided with a first elastic arm and a second elastic arm; the first elastic arm is extended towards the fiber optic cable, the second elastic arm is extended towards the first pair of plugs and the second pair of plugs; an outside of a tail end of the first elastic arm is provided with a first buckle position, the second elastic arm is provided with a second buckle position and a gear position; the second buckle position is provided on an outside of a tail end of the second elastic arm; the gear position is provided on an outside of a middle of the second elastic arm, and a first gap is provided between the second buckle position and the gear position; the unlocking tail sleeve is buckled to the first buckle position, the inner frame sleeve is buckled to the second buckle position.

In some embodiments of the present disclosure, the inner frame sleeve is provided with a first inner frame and a second inner frame; the first inner frame is communicated to the second inner frame; a width of the first inner frame is smaller than that of the second inner frame, the first inner frame faces the fiber optic cable, and the second inner frame is provided at one end facing the first pair of plugs and the second pair of plugs.

In some embodiments of the present disclosure, one end of the second inner frame facing the first pair of plugs and the second pair of plugs is provided with a first mounting port and a second mounting port that are arranged side by side; bottoms and sides of the first mounting port and the second mounting port are both provided with mounting slots; a center of the second inner frame is provided with a U-shaped bracket.

In some embodiments of the present disclosure, the unlocking tail sleeve include an unlocking frame and a tail sleeve buckled to the unlocking frame; two sides of the unlocking frame are provided with a first buckle window buckled to the first buckle position and a notch avoiding the gear position; the tail sleeve of the unlocking tail sleeve is sleeved on an outside of the fiber optic cable, and the unlocking frame is provided with a buckle wall extending to an upper side of the unlocking tail sleeve; the spring buckle is provided at one side of the buckle wall facing an outside; a second gap is provided between a bottom of the spring buckle with the inner frame sleeve and a top of the outer frame sleeve; there are two spring buckles provided at a bottom of the buckle wall; a positioning groove is provided between the two spring buckles, and a positioning notch groove is provided at a bottom of the positioning groove; the spring buckle and the positioning groove are provided within the second gap; a third gap is provided between one end of the first buckle window facing the spring buckle and the first buckle position.

In some embodiments of the present disclosure, the outer frame sleeve includes an outer frame body that is sleeved on an outside of the inner frame sleeve; a first outer frame head fixedly connected to the outer frame body and sleeved on an outside of the first pair of plugs, and a second outer frame head fixedly connected to the outer frame body and sleeved on an outside of the second pair of plugs; where the outer frame body is provided with a second buckle window that is buckled with the second buckle position; one end of the outer frame body facing the second buckle window is in the first gap; a top of the outer frame body is provided with a positioning column that is connected to the positioning notch groove, and a positioning ridge that is fixedly connected to the positioning column and meshed with the positioning groove; the spring clip includes a first spring piece provided at a top of the first outer frame head, and a second spring piece provided at a top of the second outer frame head; where a structure of the first spring piece is the same as that of the second spring piece.

In some embodiments of the present disclosure, a top of the first spring piece far away from the outer frame body is fixedly connected to a spring pressing arc arm that is arched in an opposite direction towards the outer frame body; a part of the spring pressing arc arm is provided in the second gap, and the spring pressing arc arm is extended beyond tops of the outer frame body and the inner frame sleeve; the spring pressing arc arm is arched upward; a top of the spring pressing arc arm is provided with a buckle hole; the spring buckle is buckled to the buckle hole; a top of the spring pressing arc arm abuts against the buckle wall; one end of the buckle hole facing the tail sleeve is provided with a connection chamfer that is connected to buckle hole and connected to a top of the spring pressing arc arm.

The beneficial effect of the present disclosure is to provide a reversible polarity push-pull unit-boot connector, which unlocks the tail sleeve and simultaneously buckles with the inner and outer frame sleeves, thereby ensuring a more stable overall structure and thus ensuring the stability of overall signal transmission. When polarity exchange is required, the outer frame sleeve and the unlocking tail sleeve are unlocked, the unlocking tail sleeve is retracted towards the fiber optic cable, a buckle between the inner frame sleeve of the unlocking tail sleeve is released, and then the unlocking tail sleeve is continued to retract towards the direction of the fiber optic cable. When the entire unlocking tail sleeve is retracted to a position of the fiber optic cable, the unlocking tail sleeve is rotated 180 °, and at the same time, the outer frame sleeve and the unlocking tail sleeve are unlocked. The outer frame sleeve can be retracted towards the outside, and then the outer frame sleeve is rotated 180 ° to exchange. After rotating the outer frame sleeve 180 °, the outer frame sleeve is pushed towards the direction of the inner frame sleeve until it buckles with the inner frame sleeve, and then the unlocking tail sleeve is turned towards the first pair of plugs and the second pair of plugs, until the unlocking tail sleeve is buckled to the inner frame sleeve and the unlocking tail sleeve is buckled to the outer frame sleeve, thereby completing the polarity conversion, it is simple, fast, and convenient. In the present disclosure, the unlocking tail sleeve is buckled to both the outer frame sleeve and the inner frame sleeve, rendering the overall structure more stable and ensuring the stability of overall signal transmission. The spring pressing arc arm is arched upwards, and when the spring pressing arc arm is pressed down, its end abuts against a top of the inner frame sleeve, ensuring a pressing amplitude of the top of the inner frame sleeve is not too large, thereby increasing the service life of the spring pressing arc arm.

This reversible polarity push-pull unit-boot connector has a simple and stable structure, and polarity exchange can be easily performed by pulling the unlocking tail cover. In the present disclosure, the unlocking tail sleeve is not only buckled to the outer frame sleeve by elastic compression, but also buckled to the inner frame sleeve, rendering the overall structure more stable and ensuring the stability of overall signal transmission.

### BRIEF DESCRIPTION OF DRAWINGS

FIG. 1 is a schematic structural diagram of a reversible polarity push-pull unit-boot connector according to the present disclosure.

FIG. 2 is an exploded schematic diagram of the reversible polarity push-pull unit-boot connector according to the present disclosure.

FIG. 3 is a schematic diagram of a partial structure of the reversible polarity push-pull unit-boot connector according to the present disclosure.

FIG. 4 is a schematic diagram of a partial structure of an inner frame sleeve of the reversible polarity push-pull unit-boot connector according to the present disclosure.

FIG. 5 is a schematic structural diagram of an unlocking tail sleeve of the reversible polarity push-pull unit-boot connector according to the present disclosure.

FIG. 6 is a schematic structural diagram of an outer frame sleeve of the reversible polarity push-pull unit-boot connector according to the present disclosure.

### DESCRIPTION OF EMBODIMENTS

Embodiments of the present disclosure will be described below in combination with the accompanying drawings and relevant embodiments. The embodiments of the present disclosure are not limited to the following embodiments, and the present disclosure relates to necessary components in this technical field, which should be regarded as well-known technology in this technical field and can be known and mastered by those skilled in the art.

In a description of the present disclosure, it should be noted that terms “up”, “down”, “inside”, “outside”, etc. indicate orientation or positional relationships based on the orientation or positional relationships shown in the accompanying drawings, or the orientation or positional relationships commonly used when using the product of the present disclosure. This is only for a convenience of describing the present disclosure and simplifying the description, and does not indicate or imply that the device or component referred to must have a specific orientation, be constructed and operated in a specific orientation, and therefore cannot be understood as a limitation of the present disclosure. Besides that, terms “one”, “two”, etc. are only used to distinguish descriptions and cannot be understood as indicating or implying relative importance. In the description of the present disclosure, it should be noted that unless otherwise specified and limited, terms “providing” and “connection” should be broadly understood, for example, it can be a fixed connection, a detachable connection, or an integrated connection; it can be a mechanical connection or an electrical connection; it can be directly connected, indirectly connected through an intermediate medium, or connected internally between two components. For those skilled in the art, specific meanings of the above terms in the present disclosure can be understood in a specific situation.

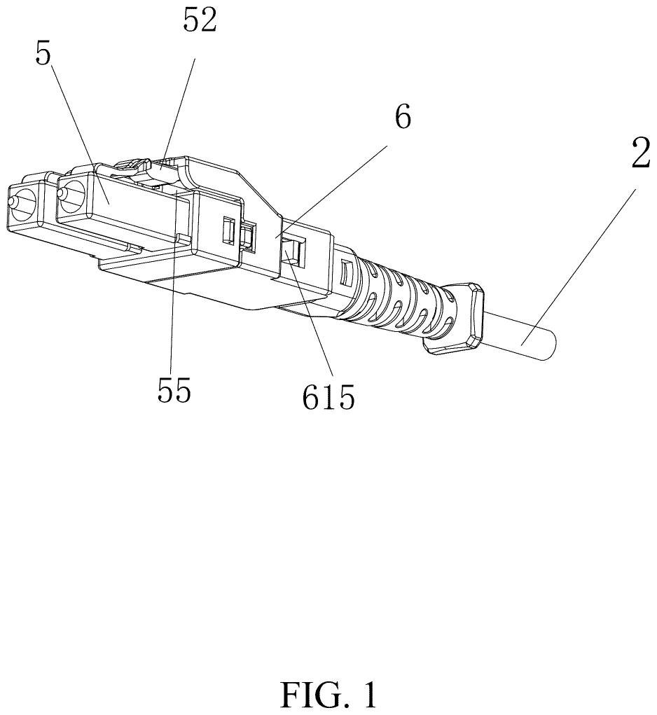

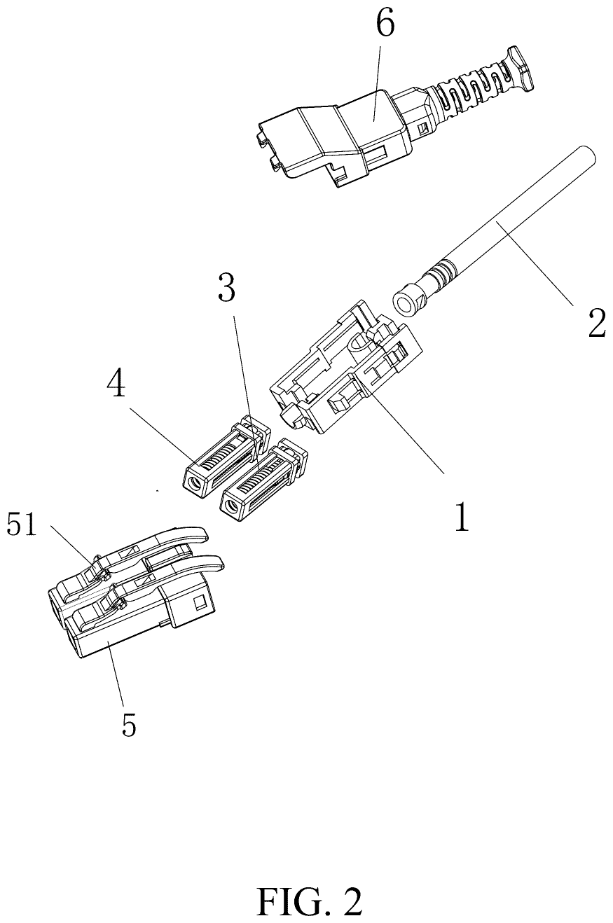

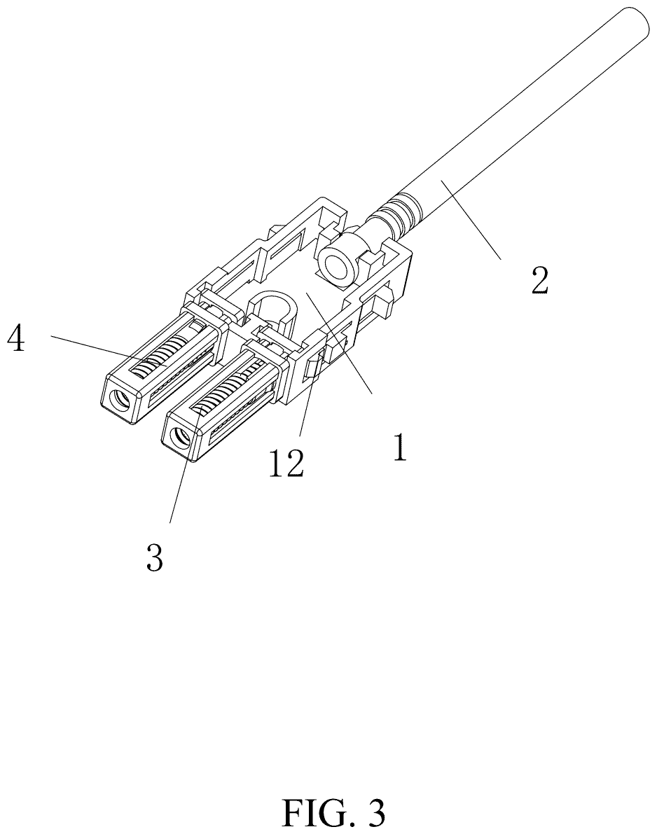

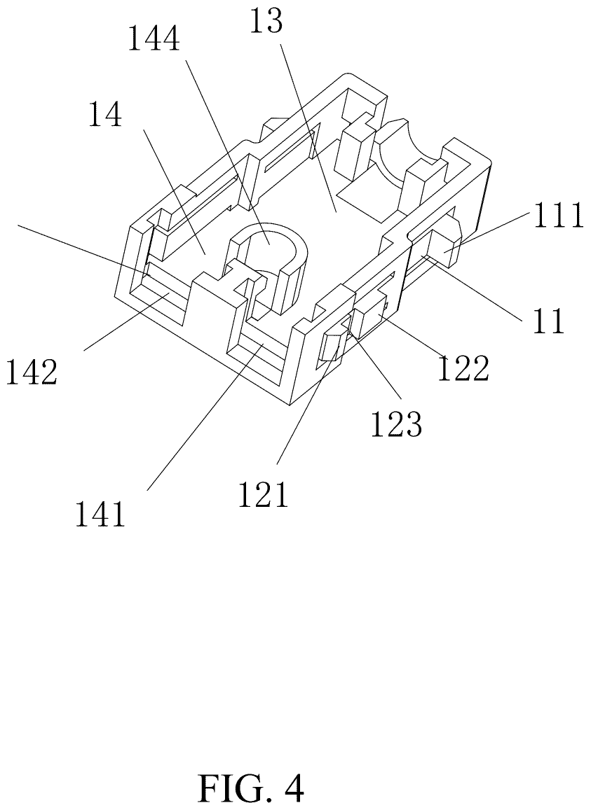

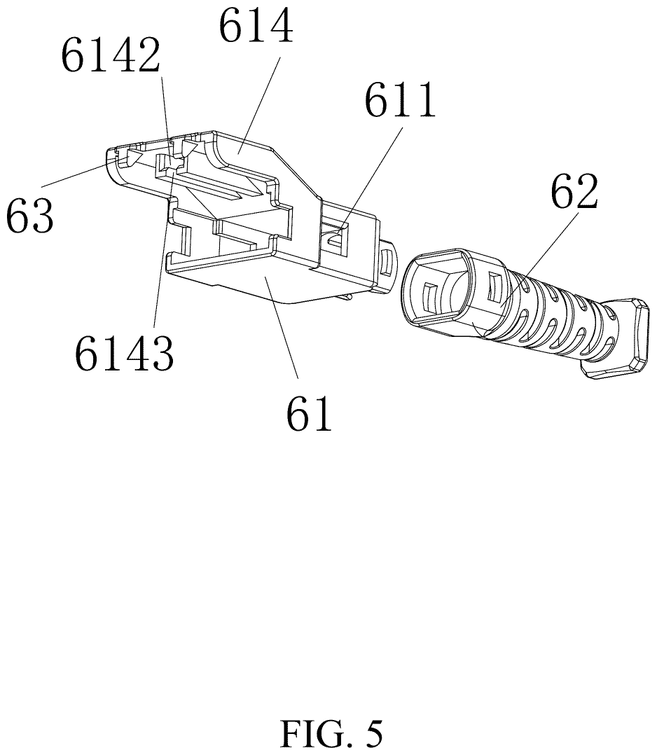

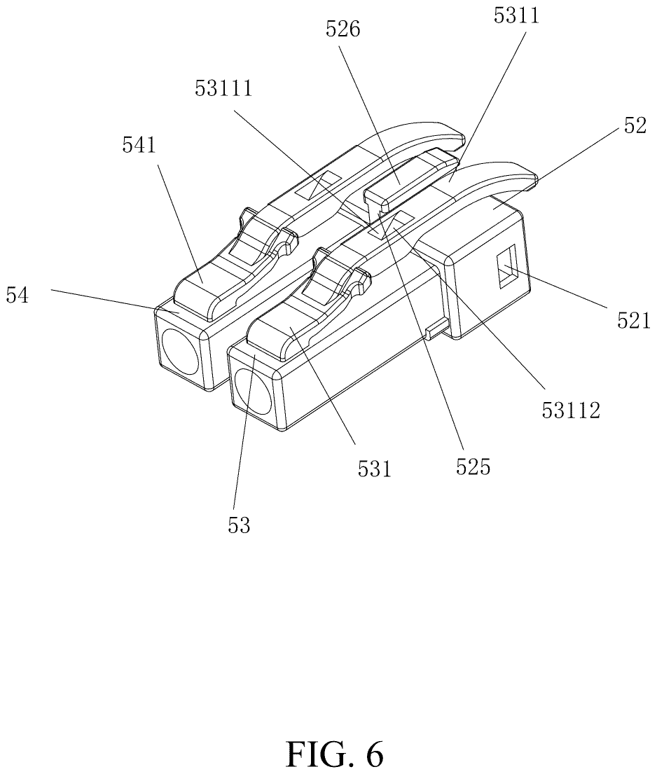

Referring to FIGS. 1 to 6, the present disclosure is implemented as follows: a reversible polarity push-pull unit-boot connector, including an inner frame sleeve 1, a fiber optic cable 2 fixedly connected to one end of the inner frame sleeve 1, a first pair of plugs 3 and a second pair of plugs 4 fixedly connected to the other end of the inner frame sleeve 1, an outer frame sleeve 5, and an unlocking tail sleeve 6. The outer frame sleeve 5 is sleeved on the first pair of plugs 3 and the second pair of plugs 4 and is buckled to an outside of the inner frame sleeve 1, the fiber optic cable 2 is connected to the first pair of plugs 3 and the second pair of plugs 4, passes through the inner frame sleeve 1 and is extended out of the inner frame sleeve 1; the unlocking tail sleeve 6 is sleeved on the outside of the inner frame sleeve 1 and is elastically buckled to the outer frame sleeve 5, and the outer frame sleeve 5 is provided with a spring clip 51. The unlocking tail sleeve 6 is provided with a spring buckle 63, the spring buckle 63 is buckled to the spring clip 51.

In a signal transmission of the present disclosure, the fiber optic cable is divided into two strands and enters an interior of the inner frame sleeve 1, respectively entering the first pair of plugs 3 and the second pair of plugs 4. The outer frame sleeve 5 is sleeved on outsides of the first pair of plugs 3 and the second pair of plugs 4, and partially sleeved on the outside of the inner frame sleeve 1 and buckled to the outside of the inner frame sleeve 1. Then, the unlocking tail sleeve 6 is sleeved from the fiber optic cable 2 towards a direction of the first pair of plugs 3 and the second pair of plugs 4. A tail of the unlocking tail sleeve 6 is sleeved on an outside of the fiber optic cable 2, and the unlocking tail sleeve is sleeved on the outside of the inner frame sleeve 1 and buckled to the inner frame sleeve 1. The unlocking tail sleeve 6 is buckled to the outer frame sleeve 5. The unlocking tail sleeve 6 is buckled to both the inner frame sleeve 1 and the outer frame sleeve 5 to ensure a more stable overall structure, thereby ensuring the stability of overall signal transmission.

When polarity needs to be changed, the outer frame sleeve 5 and the unlocking tail sleeve 6 are unlocked, the unlocking tail sleeve 6 is retracted towards a direction of the fiber optic cable 2, a buckle of the inner frame sleeve 1 of the unlocking tail sleeve 6 is released, and then the unlocking tail sleeve 6 is continued to retract towards the direction of the fiber optic cable 2. When the entire unlocking tail sleeve 6 is retracted to a position of the fiber optic cable 2, the unlocking tail sleeve 6 is rotated 180 °. At the same time, the outer frame sleeve 5 and the unlocking tail sleeve 6 are unlocked, and then the outer frame sleeve 5 is retracted towards the outside, the outer frame sleeve 5 is rotated 180 ° to exchange it. After rotating the outer frame sleeve 5 180 °, the polarity is changed, the outer frame sleeve 5 is rotated 180 ° and pushes towards the direction of the inner frame sleeve 1 until it is fully buckled with the inner frame sleeve 1, and then the unlocking tail sleeve 6 is pulled towards the direction of the first pair of plugs 3 and the second pair of plugs 4 until the unlocking tail sleeve 6 is buckled with the inner frame sleeve 1 and the unlocking tail sleeve 6 is buckled with the outer frame sleeve 5. The polarity conversion can be completed, it is simply, quick, and convenient. In the present disclosure, the unlocking tail sleeve 6 is buckled to both the outer frame sleeve 5 and the inner frame sleeve 1, rendering the overall structure more stable and ensuring the stability of overall signal transmission.

This reversible polarity push-pull unit-boot connector has a simple and stable structure, and the polarity conversion is simple.

In an implementation mode, two sides of the inner frame sleeve 1 are provided with a first elastic arm 11 and a second elastic arm 12. The first elastic arm 11 is extended in a direction of the fiber optic cable 2, and the second elastic arm 12 is extended in a direction of the first pair of plugs 3 and the second pair of plugs 4. An outer of a tail end of the first elastic arm 11 is provided with a first buckle position 111, and the second elastic arm 12 is provided with a second buckle position 121 and a gear position 122. The second buckle position 121 is provided on an outside of a tail end of the second elastic arm 12, and the gear position 122 is provided on an outside of a middle of the second elastic arm 12. A first gap 123 is provided between the second buckle position 121 and the gear position 122. The unlocking tail sleeve 6 is buckled to the first buckle position 111, and the inner frame sleeve 1 is buckled to the second buckle position 121.

The inner frame sleeve 1 is provided with a first inner frame 13 and a second inner frame 14. The first inner frame 13 is communicated to the second inner frame 14, a width of the first inner frame 13 is smaller than that of the second inner frame 14. The first inner frame 13 faces the fiber optic cable 2, and the second inner frame 14 is provided at one end facing the first pair of plugs 3 and the second pair of plugs 4.

One end of the second inner frame 14 facing the first pair of plugs 3 and the second pair of plugs 4 is provided with a first mounting port 141 and a second mounting port 142 that are arranged side by side. Bottoms and sides of the first mounting port 141 and the second mounting port 142 are both provided with mounting slots 143, and a U-shaped bracket 144 is provided in a center of the second inner frame 14.

The first pair of plugs 3 is provided in the first mounting port 141, and the second pair of plugs 4 is provided in the second mounting port 142. The first pair of plugs 3 and the second pair of plugs 4 are respectively in the mounting slots 143 at the bottom and sides of the first mounting port 141 and the second mounting port 142, ensuring that the first pair of plugs 3 and the second pair of plugs 4 can be accurately and stably provided in the first mounting port 141 and the second mounting port 142 of the inner frame sleeve 1.

The fiber optic cable 2 is divided into two strands and enters the first inner frame 13 and the second inner frame 14 of the inner frame sleeve 1, and then enters the first pair of plugs 3 and the second pair of plugs 4 respectively. The U-shaped bracket is provided in the second inner frame 14. When the fiber optic cable 2 is divided into two strands, the U-shaped bracket separates the two strands of the fiber optic cable 2 before entering the first pair of plugs 3 and the second pair of plugs 4, ensuring that the two strands of fiber optic cable 2 do not interfere with each other and become messy.

In an implementation mode, the unlocking tail sleeve 6 includes an unlocking frame 61 and a tail sleeve 62 buckled to the unlocking frame 61. Two sides of the unlocking frame 61 are provided with a first buckle window 611 buckled to the first buckle position 111, and a notch 612 avoiding the gear position 122. The tail sleeve 62 of the unlocking tail sleeve 6 is sleeved on the outside of the fiber optic cable 2. The unlocking frame 61 is provided with a buckle wall 614 extending to an upper side of the outer frame sleeve 6. The spring buckle 63 is provided at one end of the buckle wall 614 facing an outside, a second gap 55 is provided between a bottom of the spring buckle 63 with the inner frame sleeve 1 and a top of the outer frame sleeve 5. There are two spring buckle 63 provided at a bottom of the buckle wall 614. A positioning groove 6142 is provided between the two spring buckles 63, and a bottom of the positioning groove 6142 is provided a positioning notch groove 6143. The spring buckle 63, the positioning groove 6142 are provided within the second gap 55, and a third gap 615 is provided between one end of the first buckle window 611 facing the spring buckle 63 and the first buckle position 111.

When the polarity is changed, a buckle between the spring clip 61 and the spring clip 51 is released, that is, the unlocking tail sleeve 6 is released from the inner frame sleeve 1. Due to the existence of the third gap 615, the unlocking tail sleeve 6 is pushed towards the direction of the fiber optic cable 2 until there is no third gap 615 between the first buckle position 111 and the first buckle window 611. Then, the first elastic arm 11 is depressed towards a center direction of the second inner frame 14 to release a buckle between the first buckle position 111 and the second buckle window 521. As a result, the unlocking tail sleeve 6 is fully buckled with the inner frame sleeve 1 and the outer frame sleeve 5, and the unlocking tail sleeve 6 can be pushed back towards the fiber optic cable 2 by a certain distance. The unlocking frame 61 is rotated for polarity change. Thus, it is easy and convenient to operate.

In an implementation mode, the outer frame sleeve 5 includes an outer frame body 52 that is sleeved onto the outside of the inner frame sleeve 1, a first outer frame head 53 that is fixedly connected to the outer frame body 52 and sleeved onto an outside of the first pair of plugs 3, and a second outer frame head 54 that is fixedly connected to the outer frame body 52 and sleeved onto an outside of the second pair of plugs 4. The outer frame body 52 is provided with a second buckle window 521 that is buckled to the second buckle position 121, and one end of the outer frame body 52 facing a direction of the second buckle window 521 is within the first gap 123. A top of the outer frame body 52 is provided with a positioning column 525 that is fixedly connected to the positioning notch groove 6143, and a positioning ridge 526 that is fixedly connected to the positioning column 525 and engaged with positioning groove 6142. The spring clip 51 includes a first spring piece 531 provided at a top of the first outer frame head 53 and a second spring piece 541 provided at a top of the second outer frame head 54, a structure of the first spring piece 531 is the same as that of the second spring piece 541.

When it is necessary to disengage the second buckle window 521 from the second buckle position 121, the gear position 122 is pressed to easily disengage the second buckle position 121 from the second buckle window 521.

A top of the first spring piece 531, which is far away from the outer frame body 52, is fixedly connected to a spring pressing arc arm 5311 that is arched in an opposite direction towards the outer frame body 52. A part of the spring pressing arc arm 5311 is provided in the second gap 55, and the spring pressing arc arm 5311 is extended beyond tops of the outer frame body 52 and the inner frame sleeve 1. The spring pressing arc arm 5311 is arched upwards, and can be pressed downwards in the second gap 55. When the spring pressing arc arm 5311 is pressed, its end abuts against a top of the inner frame sleeve 1, ensuring that a pressing amplitude of the top of the inner frame sleeve 1 is not too large, thereby increasing the service life of the spring pressing arc arm 5311. A top of the spring pressing arc arm 5311 is provided with a buckle hole 53111, and the spring buckle 63 is buckled to the buckle hole 53111. The top of the spring pressing arc arm 5311 abuts against the buckle wall 614, and one end of the buckle hole 53111 facing the tail sleeve 62 is provided with a connection chamfer 53112 connecting the buckle hole 53111 and the top of the spring pressing arc arm 5311.

When the outer frame sleeve 5 is sleeved to the outside of the inner frame sleeve 1, the positioning column 525 of the outer frame body 52 enters the positioning notch groove 6143, and the positioning ridge 526 enters the positioning groove 6142, ensuring that the outer frame sleeve and the inner frame sleeve can be accurately positioned and assembled. The second buckle position 121 is buckled to the second buckle window 521. When the outer frame sleeve 5 needs to be released from the buckle, the gear position 122 is pressed to render the second elastic arm 12 to be recessed towards the second inner frame 14, which can release the buckle between the second buckle position 121 and the second buckle window 521. The operation is simple and convenient.

The first spring piece 531 and the second spring piece 541 are pressed, and the spring clip 61 is slid out along the connection chamfer 53112 towards the fiber optic cable 2 to release the buckle between the unlocking tail sleeve 6 and the outer frame body 52. As the spring clip 61 is slid out of the buckle hole 53111, the first elastic arm 11 is recessed towards the center of the second inner frame 14 to release the buckle between the first buckle position 111 and the second buckle window 521. As the unlocking tail sleeve 6 continues to retreat towards the fiber optic cable 2, the first spring piece 531 and the second spring piece 541 are released. Due to an upward arching of the spring pressing arc arm 5311, a rebound force of the spring pressing arc arm 5311 causes the first spring piece 531 and the second spring piece 541 to return to original positions, and after the polarity is changed, the spring clip 61 is buckled with the buckle holes 53111 of the first spring pieces 531 and second spring piece 541.

The above is only preferred embodiment of the present disclosure. It should be noted that those skilled in the art can make several improvements and embellishments without departing from the principles of the present disclosure. These improvements and embellishments should also be considered as the protection scope of the present disclosure.

What is claimed is:

1. A reversible polarity push-pull unit-boot connector, comprising an inner frame sleeve, a fiber optic cable fixedly connected to one end of the inner frame sleeve, a first pair of plugs and a second pair of plugs that are fixedly connected to the other end of the inner frame sleeve, an outer frame sleeve, and an unlocking tail sleeve;
the outer frame sleeve is sleeved on the first pair of plugs and the second pair of plugs and is buckled with an outside of the inner frame sleeve;
the fiber optic cable is connected to the first pair of plugs and the second pair of plugs, passes through the inner frame sleeve and is extended from inner frame sleeve;
the unlocking tail sleeve is sleeved on an outside of the inner frame sleeve and is buckled with the outer frame sleeve;
the outer frame sleeve is provided with a spring clip, and the unlocking tail sleeve is provided with a spring buckle, the spring buckle is buckled to the spring clip.

2. The reversible polarity push-pull unit-boot connector according to claim 1, wherein two sides of the inner frame sleeve are provided with a first elastic arm and a second elastic arm;
the first elastic arm is extended towards the fiber optic cable,
the second elastic arm is extended towards the first pair of plugs and the second pair of plugs;
an outside of a tail end of the first elastic arm is provided with a first buckle position,
the second elastic arm is provided with a second buckle position and a gear position;
the second buckle position is provided on an outside of a tail end of the second elastic arm;
the gear position is provided on an outside of a middle of the second elastic arm, and a first gap is provided between the second buckle position and the gear position;
the unlocking tail sleeve is buckled to the first buckle position, the inner frame sleeve is buckled to the second buckle position.

3. The reversible polarity push-pull unit-boot connector according to claim 2, wherein the inner frame sleeve is provided with a first inner frame and a second inner frame;
the first inner frame is communicated to the second inner frame;
a width of the first inner frame is smaller than that of the second inner frame, the first inner frame faces the fiber optic cable, and the second inner frame is provided at one end facing the first pair of plugs and the second pair of plugs.

4. The reversible polarity push-pull unit-boot connector according to claim 3, wherein one end of the second inner frame facing the first pair of plugs and the second pair of plugs is provided with a first mounting port and a second mounting port that are arranged side by side;
bottoms and sides of the first mounting port and the second mounting port are both provided with mounting slots;
a center of the second inner frame is provided with a U-shaped bracket.

5. The reversible polarity push-pull unit-boot connector according to claim 3, wherein the unlocking tail sleeve comprises an unlocking frame and a tail sleeve buckled to the unlocking frame;
two sides of the unlocking frame are provided with a first buckle window buckled to the first buckle position and a notch avoiding the gear position;
the tail sleeve of the unlocking tail sleeve is sleeved on an outside of the fiber optic cable, and the unlocking frame is provided with a buckle wall extending to an upper side of the unlocking tail sleeve;
the spring buckle is provided at one side of the buckle wall facing an outside;
a second gap is provided between a bottom of the spring buckle with the inner frame sleeve and a top of the outer frame sleeve;
there are two spring buckles provided at a bottom of the buckle wall;
a positioning groove is provided between the two spring buckles, and a positioning notch groove is provided at a bottom of the positioning groove;
the spring buckle and the positioning groove are provided within the second gap;
a third gap is provided between one end of the first buckle window facing the spring buckle and the first buckle position.

6. The reversible polarity push-pull unit-boot connector according to claim 5, wherein the outer frame sleeve comprises an outer frame body that is sleeved on an outside of the inner frame sleeve; a first outer frame head fixedly connected to the outer frame body and sleeved on an outside of the first pair of plugs, and a second outer frame head fixedly connected to the outer frame body and sleeved on an outside of the second pair of plugs;
wherein the outer frame body is provided with a second buckle window that is buckled with the second buckle position;
one end of the outer frame body facing the second buckle window is in the first gap,
a top of the outer frame body is provided with a positioning column that is connected to the positioning notch groove, and a positioning ridge that is fixedly connected to the positioning column and meshed with the positioning groove;
the spring clip comprises a first spring piece provided at a top of the first outer frame head, and a second spring piece provided at a top of the second outer frame head;
wherein a structure of the first spring piece is the same as that of the second spring piece.

7. The reversible polarity push-pull unit-boot connector according to claim 6, wherein a top of the first spring piece far away from the outer frame body is fixedly connected to a spring pressing arc arm that is arched in an opposite direction towards the outer frame body;
a part of the spring pressing arc arm is provided in the second gap, and the spring pressing arc arm is extended beyond tops of the outer frame body and the inner frame sleeve;
the spring pressing arc arm is arched upward;
a top of the spring pressing arc arm is provided with a buckle hole;
the spring buckle is buckled to the buckle hole;
a top of the spring pressing arc arm abuts against the buckle wall;
one end of the buckle hole facing the tail sleeve is provided with a connection chamfer that is connected to buckle hole and connected to a top of the spring pressing arc arm.
